(19) United States
(12) Patent Application Publication
(10) Pub. No.: US 2021/0182774 A1
(43) Pub. Date: Jun. 17, 2021

(54) INTELLIGENT PLANOGRAM PRODUCING SYSTEM AND METHOD THEREOF

(71) Applicant: INDUSTRIAL TECHNOLOGY RESEARCH INSTITUTE, Hsinchu (TW)

(72) Inventors: Chi-Chou CHIANG, Hsinchu City (TW); Wen TSUI, Zhubei City (TW); Hsin-Chien HUANG, Hsinchu City (TW)

(73) Assignee: INDUSTRIAL TECHNOLOGY RESEARCH INSTITUTE, Hsinchu (TW)

(21) Appl. No.: 16/729,954

(22) Filed: Dec. 30, 2019

(30) Foreign Application Priority Data
Dec. 11, 2019 (TW) 108145260

(51) Int. Cl. G06Q 10/08; G06K 9/62; G06T 7/70

(52) U.S. Cl. CPC G06Q 10/087; G06T 7/70; G06K 9/6215

(57) ABSTRACT

An intelligent planogram producing system and a method thereof are provided. The intelligent planogram producing method includes the following steps: obtaining a relevance between each of a plurality of objects and producing a relevance array; re-weighting the relevance array according to the displacing limitation of each object and producing at least one complete graph; obtaining a representing route of the at least one complete graph; outputting a planogram of the disposing location of each object on a shelf according to the representing route.

This application claims the benefit of Taiwan application Serial No. 108145260, filed Dec. 11, 2019, the disclosure of which is incorporated by reference herein in its entirety.

### TECHNICAL FIELD

The disclosure relates in general to an intelligent planogram producing system and method thereof capable of increasing the recognition rate.

### BACKGROUND

Planogram is a diagram indicates the placement of objects in conventional stores or warehouses. The planning of planogram plays an important role in the fields of retailing and warehousing. For the retailing field, a well-planned planogram could increase sales and make the most of the space. For the warehousing field, a well-planned planogram could increase the access rate and make the most of the space.

Conventionally, the planogram is planned by people or is produced according to the statistic analysis based on the historical data such as sales and the disposing location of products. In response to the rise of unmanned stores and unmanned warehouses, the recognition of objects on the shelf does not merely depend on human eyes. If the machine has a poor recognition rate in recognizing the objects on the shelf, access error or replenishment error may easily occur. Therefore, it has become a prominent task for the industries to provide a planogram with high recognition rate of objects.

### SUMMARY

The present disclosure relates to an intelligent planogram producing system and a method thereof capable of increasing the recognition rate of objects.

According to one embodiment of the present disclosure, an intelligent planogram producing method is provided. The intelligent planogram producing method includes the following steps: obtaining a relevance between each of a plurality of objects and producing a relevance array; re-weighting the relevance array according to the displacing limitation of each object and producing at least one complete graph; obtaining a representing route of the at least one complete graph; outputting a planogram of the disposing location of each object on a shelf according to the representing route. In the at least one complete graph, each vertex represents an object, every two vertexes are connected by an edge whose value represents a re-weighted relevance, and the representing route, being the route with minimum summation of the value of each edge, passes through each edge only once.

According to another embodiment of the present disclosure, an intelligent planogram producing system is provided. The intelligent planogram producing system includes a relevance array producing unit, a complete graph creating unit, a route analysis unit and an output unit. The relevance array producing unit is configured to obtain a relevance between each of a plurality of objects to produce a relevance array. The complete graph creating unit is configured to convert the relevance array and re-weight the relevance array according to the displacing limitation of each object to obtain at least one complete graph, wherein in the at least one complete graph, each vertex represents an object, and every two vertexes are connected by an edge whose value represents a re-weighted relevance. The route analysis unit is configured to obtain a representing route of the at least one complete graph, wherein the representing route, being the route with minimum summation of the value of each edge, passes through each edge only once. The output unit is configured to output a planogram of the disposing location of each object on a shelf according to each at least one representing route.

The above and other aspects of the disclosure will become better understood with regards to the following detailed description of the preferred but non-limiting embodiment (s). The following description is made with reference to the accompanying drawings.

### BRIEF DESCRIPTION OF THE DRAWINGS

FIG. 1 is a schematic diagram of an intelligent planogram producing system according to an embodiment.

FIG. 2 is a flowchart of an intelligent planogram producing method according to an embodiment.

FIG. 3A is a schematic diagram of to-be-placed objects according to an embodiment.

FIG. 3B is a schematic diagram of a complete graph obtained according to the relevance array of Table 1.

FIG. 3C is a schematic diagram of a representing route obtained according to FIG. 3B.

FIG. 3D is a planogram according to FIG. 3C.

FIG. 4A-4C are schematic diagrams of a complete graph obtained according to the original relevance array, a complete graph obtained according to the re-weighted relevance array, and a representing route according to another embodiment.

FIG. 5A is a schematic diagram of to-be-placed objects according to an alternate embodiment.

FIG. 5B is at least one complete graph produced by grouping and re-weighting the to-be-placed objects of FIG. 5A.

FIG. 5C is a schematic diagram of a representing route obtained according to FIG. 5B.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

The present disclosure increases the recognition rate of objects by using suitable relevance analysis method. Detailed descriptions are disclosed in several embodiments below. However, the contents disclosed in the embodiments below are not for limiting the scope of protection of the present disclosure.

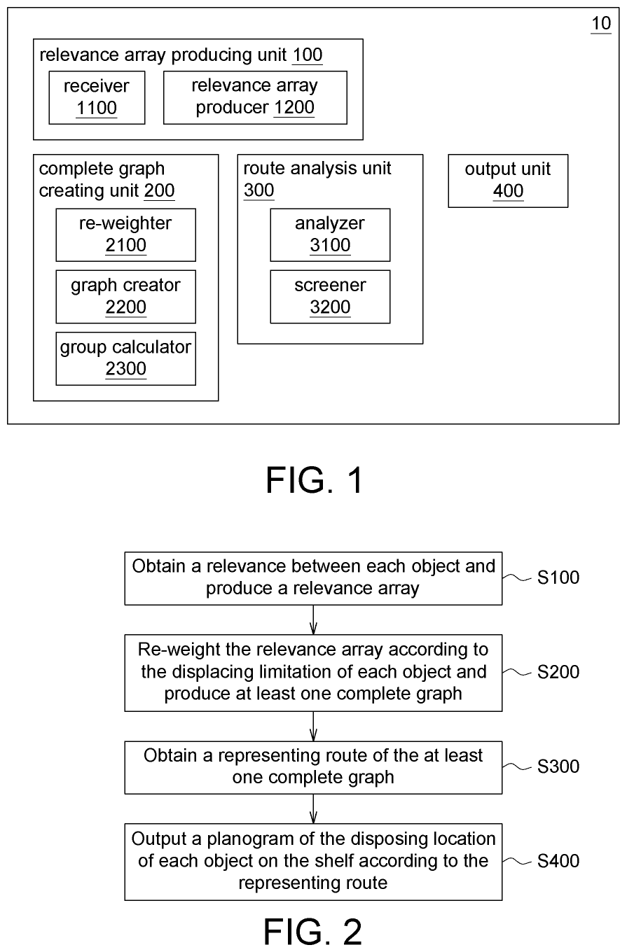

Referring to FIG. 1, a schematic diagram of an intelligent planogram producing system 10 according to an embodiment is shown. The intelligent planogram producing system 10 includes a relevance array producing unit 100, a complete graph creating unit 200, a route analysis unit 300 and an output unit 400. The relevance array producing unit 100 includes a receiver 1100 and a relevance array producer 1200. The complete graph creating unit 200 includes a re-weighter 2100, a graph creator 2200 and a group calculator 2300. The route analysis unit 300 includes an analyzer 3100 and a screener 3200. The relevance array producing unit 100, the complete graph creating unit 200, the route analysis unit 300, the receiver 1100, the relevance array producer 1200, the re-weighter 2100, the graph creator 2200, the group calculator 2300, the analyzer 3100 and the screener 3200 could be realized by such as a circuit, a chip, a circuit board, a or multiple programming codes, or a storage device storing multiple programming codes. The output unit 400 could be realized by such as a wireless network transmission device, a wired network transmission device, a memory card access device, a connection port, a keyboard, a screen, or a combination thereof. The operations of the above elements are disclosed below with a flowchart.

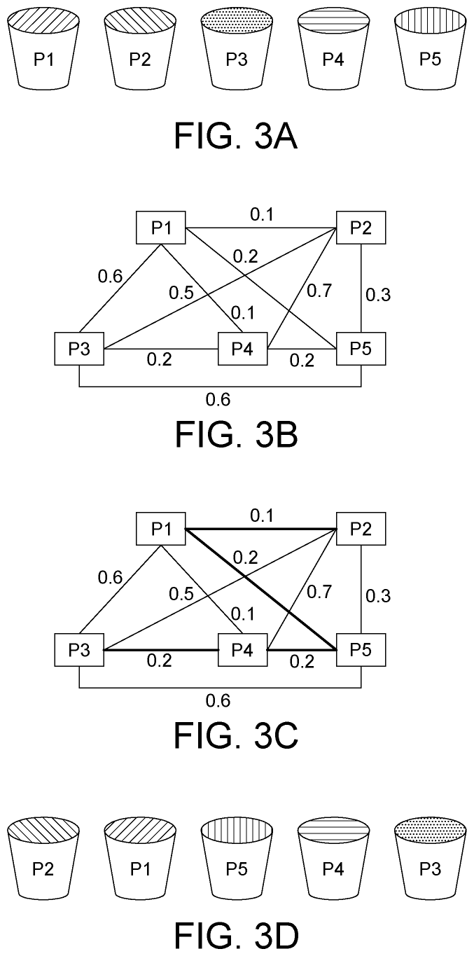

Referring to FIG. 2, a flowchart of an intelligent planogram producing method according to an embodiment is shown. In step S100, relevance between each of a plurality of to-be-placed objects is obtained by the relevance array producing unit 100 from the receiver 1100, and a relevance array is outputted by the relevance array producer 1200. Referring to FIG. 3A, a schematic diagram of to-be-placed objects according to an embodiment is shown. As indicated in FIG. 3A, the features of to-be-placed objects P1˜P5 could be obtained from the image information, the weight information, and the appearance information such as length, height or width of the objects. In the present embodiment, the image information is taken for example, but the present disclosure is not limited thereto. After the receiver 1100 receives the image information of the to-be-placed objects P1˜P5, the relevance array producer 1200 calculates a relevance between each of a plurality of the to-be-placed objects P1˜P5 and produces a relevance array as indicated in Table 1.

TABLE 1

| | P1 | P2 | P3 | P4 | P5 |
|---|---|---|---|---|---|
| P1 | 1.0 | 0.1 | 0.6 | 0.5 | 0.2 |
| P2 | 0.1 | 1.0 | 0.1 | 0.7 | 0.3 |
| P3 | 0.6 | 0.1 | 1.0 | 0.2 | 0.6 |
| P4 | 0.5 | 0.7 | 0.2 | 1.0 | 0.2 |
| P5 | 0.2 | 0.3 | 0.6 | 0.2 | 1.0 |

In step S200, the relevance array is re-weighted by the complete graph creating unit 200 according to the displacing limitation of each object to produce at least one complete graph. Referring to FIG. 3B, a schematic diagram of a complete graph obtained according to the relevance array of Table 1 is shown. In an embodiment as indicated in FIG. 3B, the to-be-placed objects P1˜P5 are represented by vertexes of the complete graph, every two vertexes are connected by an edge, which represents a re-weighted relevance between the two vertexes. In the present embodiment, since the displacing limitation has not yet been applied to the to-be-placed objects, the graph creator 2200 of the complete graph creating unit 200 could directly create a complete graph as indicated in FIG. 3B according to the relevance array produced by the relevance array producer 1200.

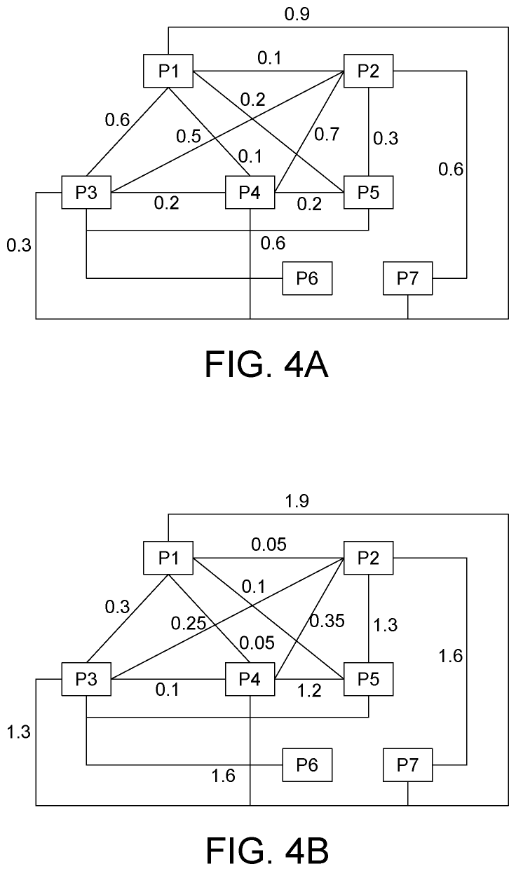

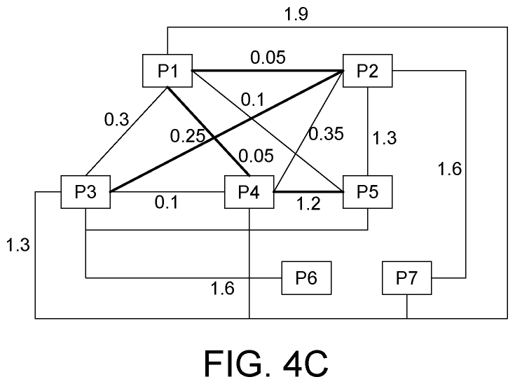

In another embodiment as indicated in FIG. 4A and FIG. 4B, a complete graph obtained according to the original relevance array and a complete graph obtained according to the re-weighted relevance array are respectively shown. In the present embodiment, given that the number of to-be-placed objects P1˜P7 is 7, the available places on the shelf is 5, and the to-be-placed objects P1˜P4 must be placed together, which means the displacing limitation of each object is adjacency and recommendation. That is, with the objects P1˜P4 taking 4 of the 5 places, there is an available place left unoccupied, and one of the objects P5˜P7 could be recommended to take this place. Based on the displacing limitation of each object disclosed above, the re-weighter 2100 of the complete graph creating unit 200 provides a corresponding weight. For example, if the objects P1˜P4 must be adjacent, then the re-weighter 2100 provides a weight, such as 0.5. When the weight is multiplied by the original relevance value, the weighted value of each edge of the objects P1˜P4 on the complete graph is less than the original relevance. Besides, the original relevance value could be deducted by the weight, and the weight could be any value as long as the weighted value of the edge whose vertexes are subjected to the displacing limitation of adjacency is less than the original relevance, and the present disclosure is not limited thereto. If the displacing limitation of each objects P5˜P7 is recommendation, then the re-weighter 2100 provides another weight, such as 1. When another weight is added to the original relevance value, the weighted value of each edge connecting one of the objects P5˜P7 and other vertex on the complete graph is greater than the original relevance. Or, the another weight could be set to be greater than 1, and the original relevance value is multiplied by the another weight, and the weight could be any value as long as the weighted value of the edge whose vertexes are subjected to the displacing limitation of recommendation is greater than the original relevance. Through the re-weighting operation of the re-weighter 2100, the graph creator 2200 could produce a complete graph as indicated in FIG. 4B.

In the embodiment as indicated in FIGS. 4A and 4B, the relevance array is firstly converted to a complete graph (FIG. 4A), and then the value of each edge is re-weighted to produce a re-weighted complete graph (FIG. 4B). According to the present disclosure, instead of producing a complete graph as indicated in FIG. 4A and then producing a re-weighted complete graph as indicated in FIG. 4B, the relevance array of Table 1 could be directly re-weighted to produce a re-weighted complete graph.

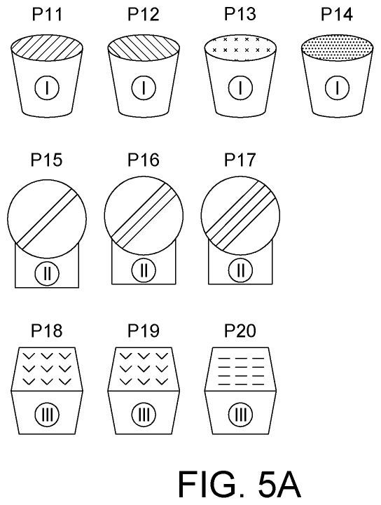

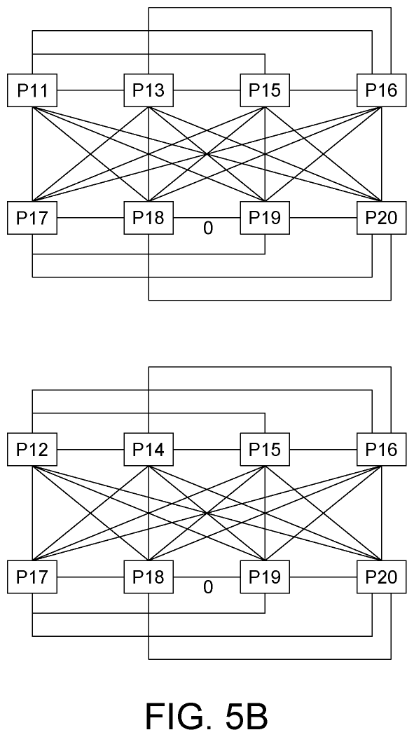

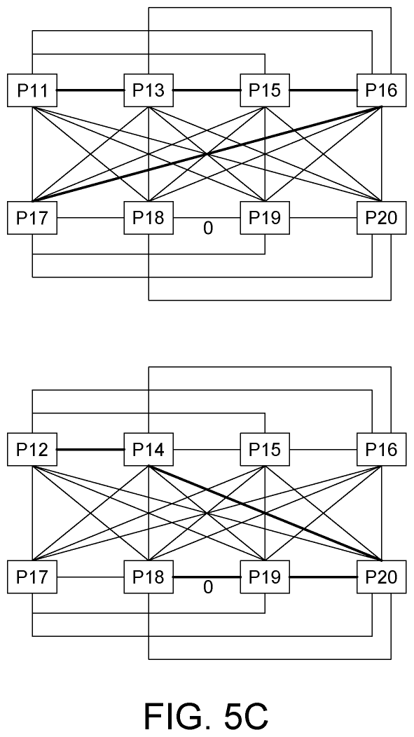

Referring to FIG. 5A, a schematic diagram of to-be-placed objects according to an alternate embodiment is shown. Among the to-be-placed objects P11˜P20, the to-be-placed objects P11˜P14, P15˜P17 and P18˜P20 respectively are of the same brand. The objects P18 and P19 are of the same object. Since one layer of the shelf could serve only 5 objects and objects of the same brand need to be placed together, the displacing limitation of each object is adjacency and repetition. Due to the restriction of available places on one layer of the shelf, the group calculator 2300 of the complete graph creating unit 200, first of all, divides the to-be-placed objects P11˜P20 into different groups. For example, the group calculator 2300 performs the multi-label graph cut grouping algorithm to divide the objects P11˜P14 into two groups. Furthermore, since objects of the same brand need to be placed together, the group calculator 2300 performs grouping in the manner that the relevance between the two groups is minimized but the relevance within the same group is maximized. For example, the objects P11 and P13 are grouped as one group, and the objects P12 and P14 are grouped as another group. Then, the re-weighter 2100 performs re-weighting according to the displacing limitation of each object to produce two complete graphs. For the objects subjected to the displacing limitation of adjacency, the re-weighting operation is already disclosed above and therefore is not repeated here. For the objects subjected to the displacing limitation of repetition, the re-weighter 2100 provides a weight, which causes the weighted value of the edge whose vertexes are subjected to the displacing limitation of repetition to be equivalent to 0. Then, the graph creator 2200 of the complete graph creating unit 200 produces two complete graphs, wherein the vertexes of one complete graph include P11, P13, and P15˜P20, the vertexes of the other complete graph include P12, P14 and P15˜P20 as indicated in FIG. 5B. FIG. 5B is at least one complete graph produced by grouping and re-weighting the to-be-placed objects of FIG. 5A. To make the complete graph simple and easy to read, only the edge length of the objects P18 and P19 are marked. Since the displacing limitation of each object is repetition, the re-weighted value of edge length is equivalent to 0, and the values of remaining edge lengths, which are re-weighted in the same way as the above embodiment, are not repeated here.

Then, the method proceeds to step S300, a representing route of each of the at least one complete graph is obtained by the route analysis unit 300 through analysis. Referring to FIG. 3C. Through analysis, the route analysis unit 300 could obtain a route, which passes through each edge only once and has the minimum summation of the value of each edge. This route, marked by bold lines, is referred as the representing route. In step S400, a planogram of the disposing location of each of the objects P1˜P5 on the shelf as indicated in FIG. 3D is outputted by the output unit 400 according to the representing route. FIG. 3D is a planogram according to FIG. 3C. As indicated in FIG. 3D, the objects are disposed form left to right in the order of P2, P1, P5, P4 and P3, and the order of the objects corresponds to the order of the vertexes on the representing route of FIG. 3C. Also, the left-to-right order could be reversed to a right-to-left order, by which the objects are disposed in the order of P3, P4, P5, P1 and P2 as long as the relevance between adjacent objects is the minimum. Thus, the recognition rate of objects could be increased, and recognition error could be reduced.

According to another embodiment, in step S300, since the number of placeable objects is 5, the analyzer 3100 of the route analysis unit 300 could analyze the complete graph to obtain multiple routes, which pass through any 5 vertexes but pass through the edges of the 5 vertexes only once and further summarize these routes as a route list. Then, the screener 3200 of the route analysis unit 300 screens the route list to obtain a route with a minimum summation of the value of each edge as the representing route as indicated in FIG. 4C. As indicated in FIG. 4C, the representing route includes 5 vertexes in the order of P3, P2, P1, P4 and P5, and the reverse order would also do. Thus, the route analysis unit 300 of the present disclosure recommends the object P5 rather than the object P6 or the object P7. In step S400, a planogram of the disposing location of each object on the shelf is outputted by the output unit 400 according to the representing route.

According to an alternate embodiment, in step S300, since one layer of the shelf could serve only 5 objects, the analyzer 3100 of the route analysis unit 300 could analyze the two complete graphs to obtain multiple routes, which pass through any 5 vertexes but pass through the edges of the 5 vertexes only once and further summarize these routes as a route list. Then, the screener 3200 of the route analysis unit 300 screens the route list to obtain a route with a minimum summation of the value of each edge as the representing route as indicated in FIG. 5C. Lastly, in step S400, a planogram of the disposing location of each object on the shelf is outputted by the output unit 400 according to the representing route. The operation in this regard is similar to that in the above embodiment, and the details are not repeated here.

According to the intelligent planogram producing system and method disclosed in above embodiments, a planogram with higher recognition rate is obtained according to the relevance array, the re-weighting of the complete graph and the analysis of the representing route. Thus, the unmanned store or the unmanned warehouse could increase the accuracy of object disposition and make the most of the space.

It will be apparent to those skilled in the art that various modifications and variations could be made to the disclosed embodiments. It is intended that the specification and examples be considered as exemplary only, with a true scope of the disclosure being indicated by the following claims and their equivalents.

What is claimed is:

1. A intelligent planogram producing method, comprising:
obtaining a relevance between each of a plurality of objects and producing a relevance array;
re-weighting the relevance array according to displacing limitation of each object and producing at least one complete graph;
obtaining a representing route of the at least one complete graph;
outputting a planogram of the disposing location of each object on a shelf according to the representing route.
wherein in the at least one complete graph, each vertex represents the corresponding object, every two vertexes are connected by an edge whose value represents a re-weighted relevance, and the representing route, being the route with minimum summation of the value of each edge, passes through each edge only once.

2. The intelligent planogram producing method according to claim 1, wherein the step of obtaining the representing route of the at least one complete graph comprises:
obtaining the number of placeable objects n;
analyzing each route containing n vertexes of the at least one complete graph to obtain a route list; and
obtaining the representing route with minimum summation of the value of each edge from the route list.

3. The intelligent planogram producing method according to claim 1, wherein the step of re-weighting the relevance array according to the displacing limitation of each object and producing at least one complete graph further comprises: grouping the objects by using a grouping algorithm to produce the at least one complete graph whose the number corresponds to the number of groups of the objects, and the vertexes between the at least one complete graph are not connected.

4. The intelligent planogram producing method according to claim 1, wherein the step of re-weighting the relevance array according to the displacing limitation of each object and producing at least one complete graph comprises:
setting a first weight when the displacing limitation of each object is adjacency;
causing the value of each edge whose connecting vertexes are subjected to the displacing limitation of adjacency re-weighted by the first weight to be less than the original relevance; and
producing the at least one complete graph.

5. The intelligent planogram producing method according to claim 1, wherein the step of re-weighting the relevance array according to the displacing limitation of each object and producing at least one complete graph comprises:
setting a second weight when the displacing limitation of each object is repetition;
causing the value of each edge whose connecting vertexes are subjected to the displacing limitation of repetition re-weighted by the second weight to be equivalent to 0; and
producing the at least one complete graph.

6. The intelligent planogram producing method according to claim 1, wherein step of re-weighting the relevance array according to the displacing limitation of each object and producing at least one complete graph comprises:
setting a third weight when the displacing limitation of each object is recommendation;
causing the value of each edge whose vertexes are subjected to the displacing limitation of recommendation re-weighted by the third weight to be greater than the original relevance; and
producing the at least one complete graph.

7. The intelligent planogram producing method according to claim 6, wherein when the displacing limitation of each object is recommendation, the method further comprises: defining the objects as a second candidate object, and defining the remaining objects as a first candidate object.

8. The intelligent planogram producing method according to claim 7, wherein the representing route must pass through all vertexes representing the first candidate object.

9. The intelligent planogram producing method according to claim 1, wherein the relevance between each object is calculated from the image, the weight or the similarity of appearance of the objects or are defined by the user.

10. A intelligent planogram producing system, comprising:
a relevance array producing unit configured to obtain a relevance between each of a plurality of objects to produce a relevance array;
a complete graph creating unit configured to convert the relevance array and re-weight the relevance array according to the displacing limitation of each object to obtain at least one complete graph, wherein in the at least one complete graph, each vertex represents the corresponding object, and each vertex are connected by an edge whose value represents a re-weighted relevance;
a route analysis unit configured to obtain a representing route of the at least one complete graph, wherein the representing route, being the route with minimum summation of the value of each edge, passes through each edge only once; and
an output unit configured to output a planogram of the disposing location of each object on a shelf according to each at least one representing route.

11. The intelligent planogram producing system according to claim 10, wherein the complete graph creating unit comprises:
a re-weighter configured to provide a corresponding weight according to the displacing limitation of each objects to obtain a re-weighted relevance array; and
a graph creator configured to create the at least one complete graph according to the re-weighted relevance array.

12. The intelligent planogram producing system according to claim 11, wherein the complete graph creating unit further comprises a group calculator configured to group each object, and the graph creator creates a corresponding number of at least one complete graph according to the number of groups of the objects.

13. The intelligent planogram producing system according to claim 10, wherein the route analysis unit comprises:
an analyzer configured to analyze any routes passing through n vertexes of the at least one complete graph to obtain a route list; and
a screener configured to obtain each representing route according to the relevance value corresponding to each route list;
wherein n represent the number of placeable objects.

14. The intelligent planogram producing system according to claim 10, wherein the relevance array producing unit comprises:
a receiver configured to receive the image information, the weight information or the appearance information of each object; and
a relevance array producer configured to calculate the relevance of each object according to the image information, the weight information or the appearance information and produce the relevance array.

15. The intelligent planogram producing system according to claim 11, wherein when the displacing limitation of each object is adjacency, the re-weighter provides a first weight, which causes the value of each edge weighted by the first weight to be less than the original relevance.

16. The intelligent planogram producing system according to claim 11, wherein when the displacing limitation of each object is repetition, the re-weighter provides a second weight, which causes the value of each edge weighted by the second weight to be equivalent to 0.

17. The intelligent planogram producing system according to claim 11, wherein when the displacing limitation of each object is recommendation, the re-weighter provides a third weight, which causes the value of each edge weighted by the third weight to be greater than the original relevance.
